(19) United States
(12) Patent Application Publication
(10) Pub. No.: US 2024/0397481 A1
(43) Pub. Date: Nov. 28, 2024

(54) CARRIER SELECTION FOR PAGING ON FLEXIBLE CELL

(71) Applicant: QUALCOMM Incorporated, San Diego, CA (US)

(72) Inventors: Kexin XIAO, Shanghai (CN); Hung Dinh LY, San Diego, CA (US); Huilin XU, Temecula, CA (US)

(21) Appl. No.: 18/694,862

(22) PCT Filed: Nov. 15, 2021
(86) PCT No.: PCT/CN2021/130543

§ 371 Date: Mar. 22, 2024

(51) Int. Cl. H04W 68/02; H04W 72/23

(52) U.S. Cl. CPC H04W 68/02; H04W 72/23

(57) ABSTRACT

Method and apparatus for carrier selection for paging on a flexible cell. The apparatus receives an indication to monitor at least one carrier from a flexible cell for a paging message. The flexible cell comprising an anchor carrier and one or more non-anchor carriers. The apparatus monitors a first carrier from the flexible cell for the paging message based on the indication, the paging message associated with a PDCCH that schedules a PDSCH. The apparatus may receive, from the flexible cell, a downlink BWP configuration for the anchor carrier and the one or more non-anchor carriers.

### TECHNICAL FIELD

The present disclosure relates generally to communication systems, and more particularly, to a configuration for carrier selection for paging on a flexible cell.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus receives an indication to monitor at least one carrier from a flexible cell for a paging message. The flexible cell comprising an anchor carrier and one or more non-anchor carriers. The apparatus monitors a first carrier from the flexible cell for the paging message based on the indication, the paging message associated with a physical downlink control channel (PDCCH) that schedules a physical downlink shared channel (PDSCH).

In an aspect of the disclosure, a method, a computer-readable medium, and an apparatus are provided. The apparatus may be a device at a base station. The device may be a processor and/or a modem at a base station or the base station itself. The apparatus transmits, to at least a user equipment (UE), an indication to monitor at least one carrier from a flexible cell for a paging message. The flexible cell comprising an anchor carrier and one or more non-anchor carriers. The apparatus transmits the paging message on a first carrier from the flexible cell based on the indication. The paging message associated with a physical downlink control channel (PDCCH) that schedules a physical downlink shared channel (PDSCH).

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a flexible carrier.

FIG. 5 is a diagram illustrating an example of a paging sequence.

FIG. 6 is a diagram illustrating an example of a frequency offset for carriers.

FIG. 7 is a call flow diagram of signaling between a UE and a base station.

FIG. 8 is a flowchart of a method of wireless communication.

FIG. 9 is a flowchart of a method of wireless communication.

FIG. 10 is a diagram illustrating an example of a hardware implementation for an example apparatus.

FIG. 11 is a flowchart of a method of wireless communication.

FIG. 12 is a flowchart of a method of wireless communication.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

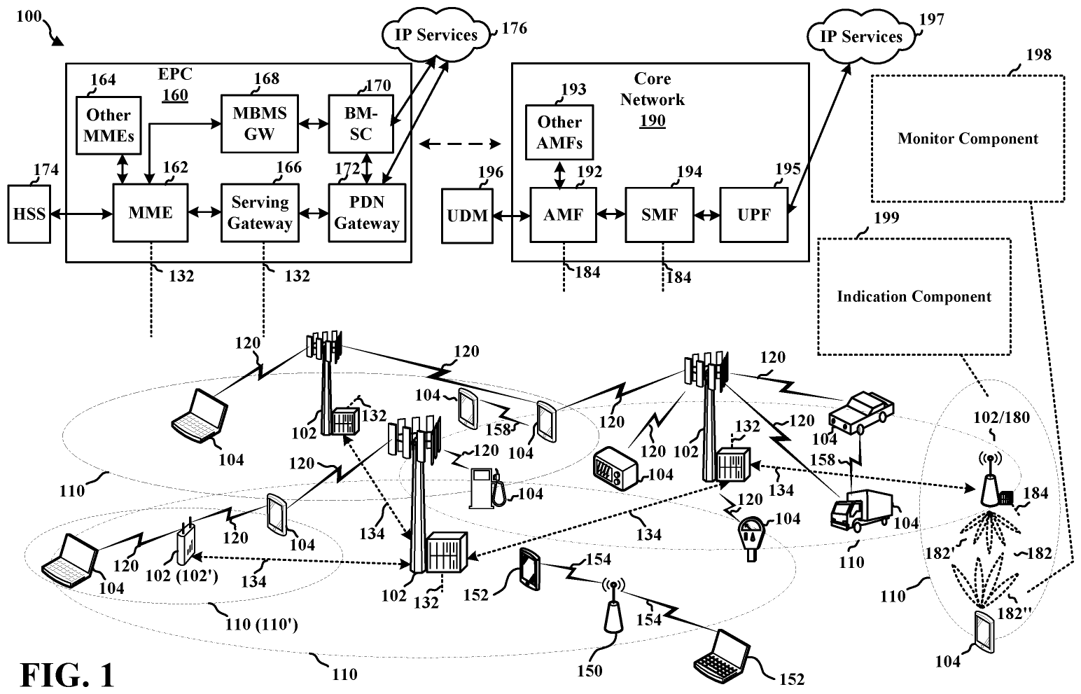

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to monitor one or more carriers of a flexible cell for paging messages. For example, the UE 104 may comprise a monitor component 198 configured to monitor one or more carriers of a flexible cell for paging messages. The UE 104 may receive an indication to monitor at least one carrier from a flexible cell for a paging message. The flexible cell comprising an anchor carrier and one or more non-anchor carriers. The UE 104 may monitor a first carrier from the flexible cell for the paging message based on the indication. The paging message associated with a PDCCH that schedules a PDSCH.

Referring again to FIG. 1, in certain aspects, the base station 180 may be configured to configure a UE to monitor one or more carriers of a flexible cell for paging messages. For example, the base station 180 may comprise an indication component 199 configured to configure a UE 104 to monitor one or more carriers of a flexible cell for paging messages. The base station 180 may transmit, to at least a UE 104, an indication to monitor at least one carrier from a flexible cell for a paging message. The flexible cell comprising an anchor carrier and one or more non-anchor carriers. The base station 180 may transmit the paging message on a first carrier from the flexible cell based on the indication. The paging message associated with a PDCCH that schedules a PDSCH.

Although the following description may be focused on 5G NR, the concepts described herein may be applicable to other similar areas, such as LTE, LTE-A, CDMA, GSM, and other wireless technologies.

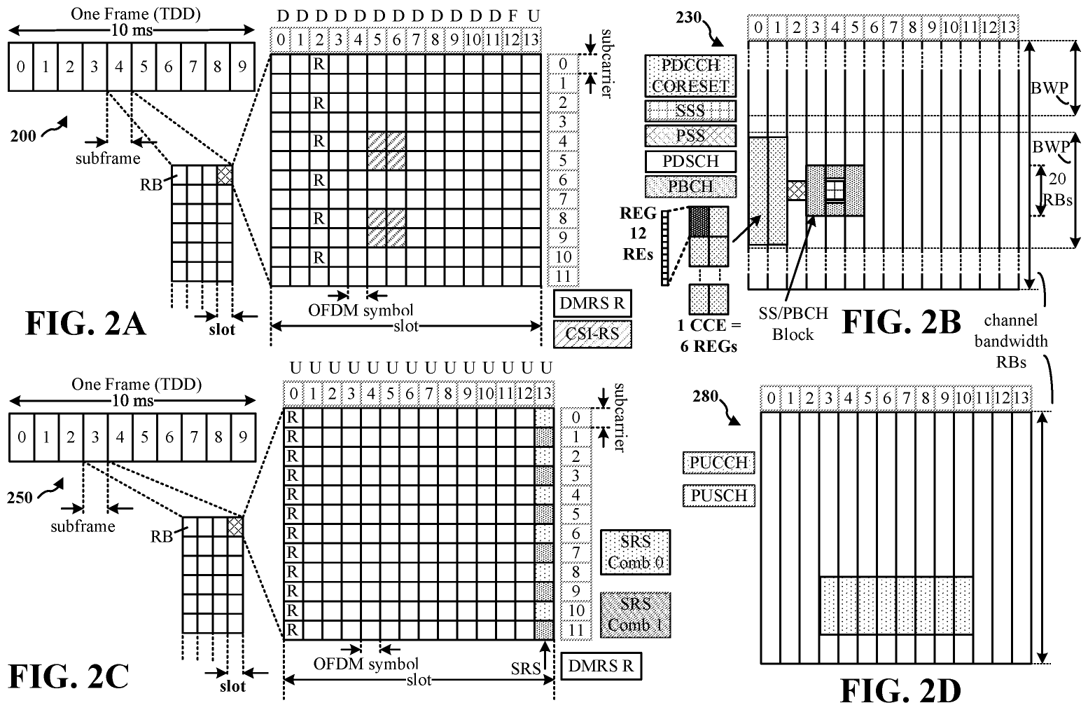

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology u=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

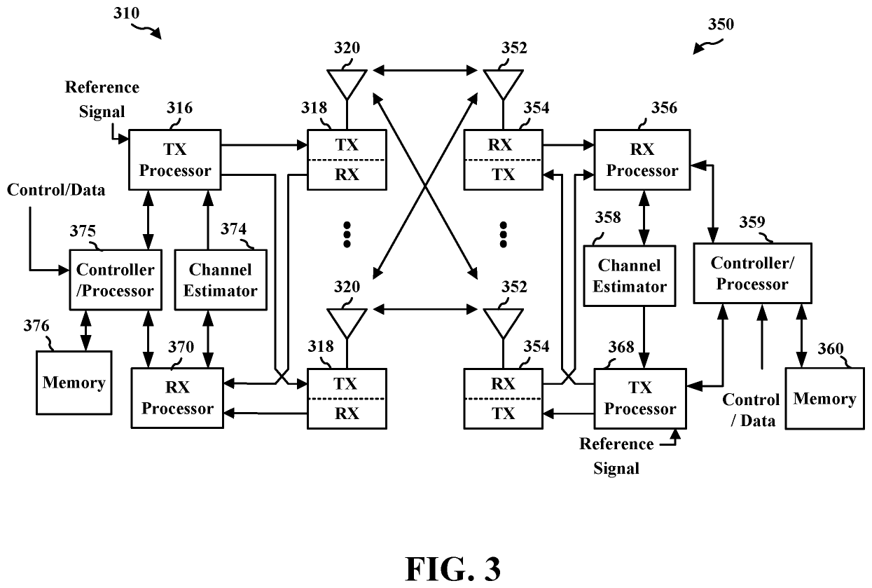

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

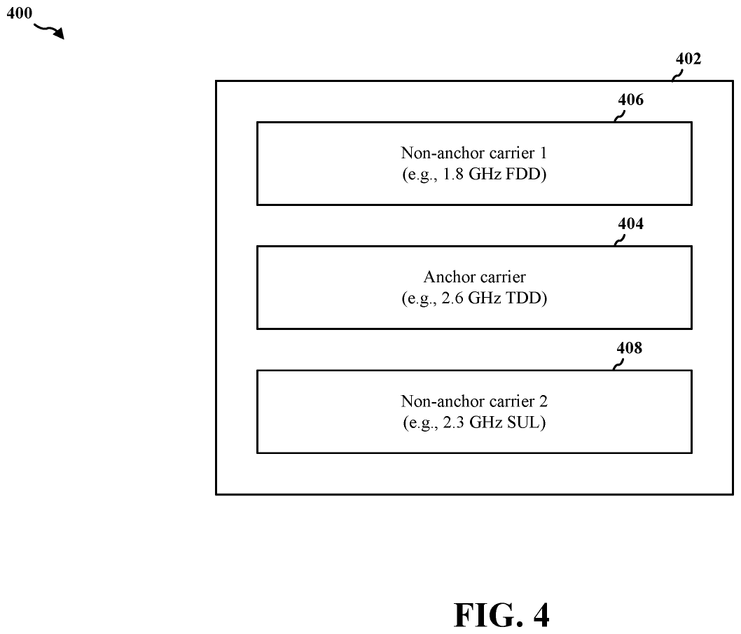

In wireless communications, a flexible cell may comprise a cell with a collection of multiple carriers. The multiple carriers may be any combination of carriers for frequency domain duplex (FDD), time domain duplex (TDD), or supplementary uplink (SUL) operation. The multiple carriers may enable flexible use of the spectrum re-farmed from LTE deployment. The carriers may be non-contiguous, and the base station may only transmit SSB or SI on an anchor carrier. However, paging messages and procedure may be performed in either the anchor carrier of the non-anchor carriers. For example, with reference to diagram 400 of FIG. 4, the flexible cell 402 may comprise an anchor carrier 404, a first non-anchor carrier 406, and a second non-anchor carrier 408. The anchor carrier may be configured for TDD (e.g., 2.6 GHZ TDD). The first non-anchor carrier may be configured for FDD (e.g., 1.8 GHz FDD), while the second non-anchor carrier may be configured for SUL (e.g., 2.3 GHZ SUL). Communication over a set of carriers may be performed by existing carrier aggregation (CA) framework in which the network configures multiple cells separately on the carriers and configures carrier aggregation feature to the UE. However, the CA framework may incur high signaling overhead for configuring and/or managing a complex cell management that may include the flexible cell framework.

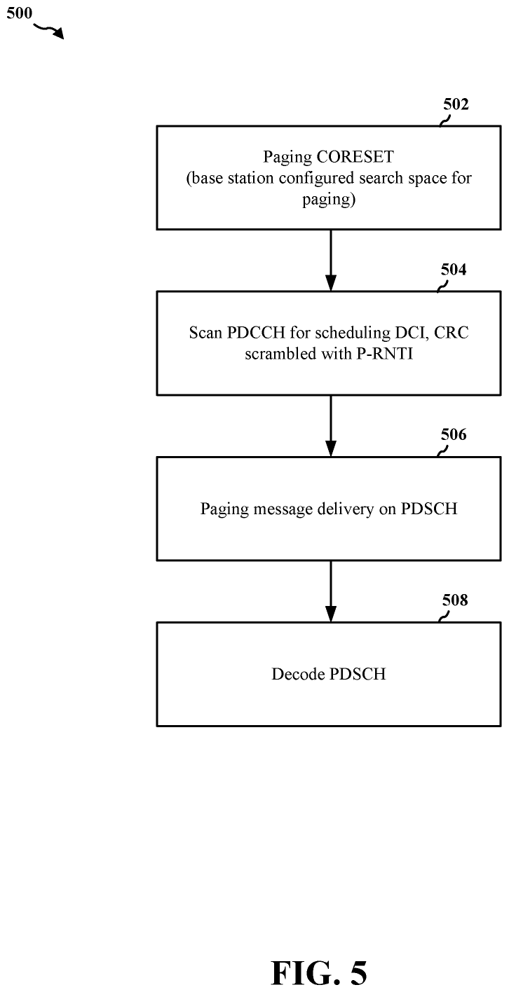

A paging message may originate from a base station or a core network element. The network may transmit a paging message to a UE in RRC idle mode or RRC inactive mode to initiate a connection setup. The base station may transmit a paging message to inform the UE about the change in system information, an emergency notification, an earthquake or tsunami warning notification, or the like. The UE may use discontinuous reception (DRX) in RRC_IDLE or RRC_INACTIVE state in order to reduce power consumption. The UE may monitor one paging occasion (PO) per DRX cycle. For example, with reference to diagram 500 of FIG. 5, a paging CORESET 502 may be configured by the base station for a search space for paging. The UE may scan for PDCCH 504 for a scheduling DCI, where a cyclic redundancy check (CRC) may be scrambled with a paging radio network temporary identifier (P-RNTI). A paging message 506 may be delivered via PDSCH. The UE may then decode the PDSCH 508.

A paging early indication, prior to a target PO, may indicate to the UE whether to monitor the PDCCH scrambled with the P-RNTI at the PO. In some instances, for UE subgroups indication in the physical layer, a maximum of 8 subgroups per PO may be supported. In some instances, the PDCCH, a secondary synchronization signal (SSS), a tracking reference signal (TRS), or CSI-RS may be based on PEI. In some instances, TRS/CSI-RS may be utilized for idle or inactive UEs which may allow such UEs to refine time-frequency tracking to improve UE operation, e.g., PDCCH/PDSCH reception in idle or inactive modes. TRS/CSI-RS occasions for idle or inactive UEs may be used as an availability indication, such as, for paging PDCCH based availability indication of TRS/CSI-RS occasions for idle/inactive UEs; PEI based availability indication of TRS/CSI-RS occasions for idle/inactive UEs; or SIB based availability indication.

PDCCH or PDSCH in paging may be transmitted in an anchor carrier. For a flexible cell, N non-anchor carriers may be configured, where N>1, in addition to the anchor carrier. The UE may be configured to monitor paging messages over one of the carriers.

Aspects presented herein provide a configuration to enable carrier selection for UEs to monitor the paging message. For example, the UE may be indicated which carrier in the flexible cell to monitor for paging, PEI, or idle TRS. In another example, the UE may be provided with the carrier to monitor the PDCCH having the DCI scheduling a PDSCH, or which carrier to monitor for the PDSCH.

In some instances, the carrier for the UE to monitor the paging PDCCH and/or the receiving paging PDSCH may be explicitly indicated in SI, MIB, PEI, or paging TRS availability indication. In some instances, the UE may receive the PDCCH and the PDSCH in the same indicated carrier. In some instances, the carrier for the UE to receive PDCCH having a DCI scheduling PDSCH may be different from the carrier for the UE to receive the PDSCH.

In some instances, the carrier for the UE to monitor the paging PDCCH and to receive the paging PDSCH may be the same as the carrier the UE receives SSB or the carrier that the UE receives SIB1. This may be a fallback option in instances where the carrier for the UE to monitor for the paging PDCCH and/or the receiving paging PDSCH is not explicitly indicated in the SI, MIB, PEI, or paging TRS availability indication. In some aspects, the paging PDCCH may comprise a field that indicates the carrier for the UE to monitor to receive the paging PDSCH.

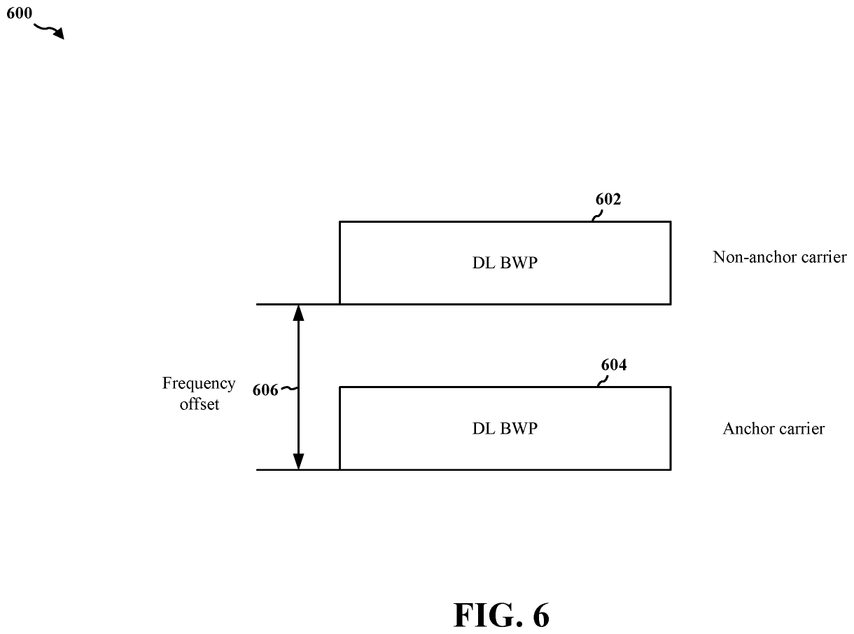

In some instances, the downlink BWP configuration for the UE to receive the paging message (e.g., PDCCH or PDSCH) for each carrier may be indicated in SI. Each carrier may comprise a separate DL BWP. The DL BWP for each carrier may be separated by a frequency offset, where the UE may monitor for paging in the anchor carrier. For example, with reference to diagram 600 of FIG. 6, the downlink BWP 602 for the non-anchor carrier may be separated by the frequency offset 606 from the downlink BWP 604 for the anchor carrier. In some instances, the unit of the offset may be in the SCS of the downlink BWP (e.g., 604) in the anchor carrier. In some instances, the unit of the offset may be pre-configured. In some instances, the unit of the offset may be in the SCS of the downlink BWP (e.g., 602) in the non-anchor carrier.

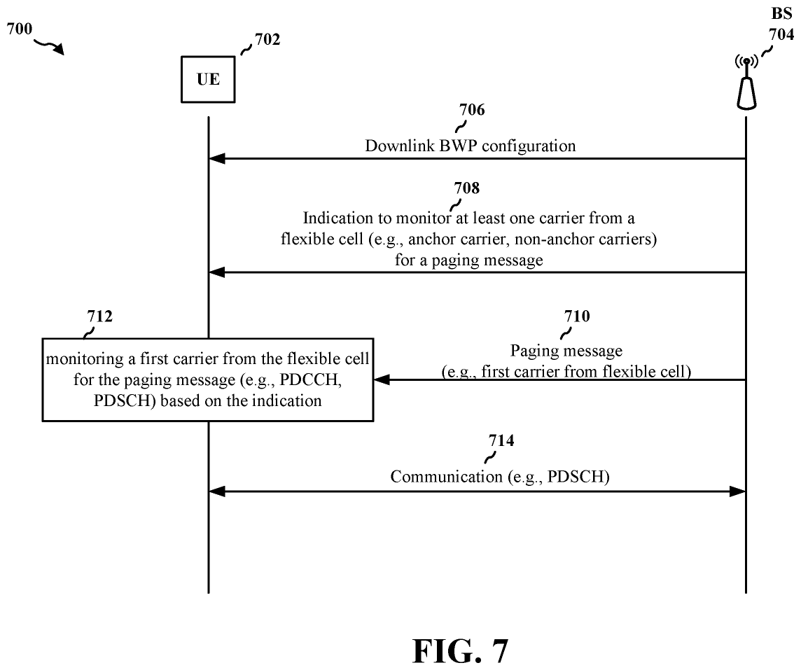

FIG. 7 is a call flow diagram 700 of signaling between a UE 702 and a base station 704. The base station 704 may be configured to provide at least one cell. The UE 702 may be configured to communicate with the base station 704. For example, in the context of FIG. 1, the base station 704 may correspond to base station 102/180 and, accordingly, the cell may include a geographic coverage area 110 in which communication coverage is provided and/or small cell 102′ having a coverage area 110′. Further, a UE 702 may correspond to at least UE 104. In another example, in the context of FIG. 3, the base station 704 may correspond to base station 310 and the UE 702 may correspond to UE 350.

At 706, the base station 704 may transmit a downlink BWP configuration. The base station 706 may transmit the downlink BWP configuration to the UE 702. The UE 702 may receive the downlink BWP configuration from the base station 704. The downlink BWP configuration may correspond to at least an anchor carrier and one or more non-anchor carriers. In some aspects, each carrier of the flexible cell may comprise a respective downlink BWP. Each downlink BWP may be separated by a frequency offset. In some aspects, a unit of the frequency offset may be based on a SCS of the downlink BWP for the anchor carrier. In some aspects, the unit of the frequency offset may be predetermined. In some aspects, the unit of the frequency offset may be based on a SCS of the downlink BWP for the one or more non-anchor carriers. In some aspects, the paging messages may be transmitted in the anchor carrier.

At 708, the base station 704 may transmit an indication to monitor at least one carrier from a flexible cell. The base station may transmit the indication to monitor the at least one carrier from the flexible cell to the UE 702. The UE 702 may receive the indication to monitor the at least one carrier from the flexible cell associated with the base station 704. The base station may transmit the indication to monitor the at least one carrier from the flexible cell for a paging message. The base station may comprise the flexible cell. The flexible cell may comprise an anchor carrier and one or more non-anchor carriers. In some aspects, the indication may comprise at least one of a system information (SI), a MIB, a paging early indication (PEI), or a paging tracking reference signal (TRS) availability indication. In some aspects, the indication may schedule the first carrier from the flexible cell for reception of the PDCCH and the PDSCH.

At 710, the base station 704 may transmit the paging message on a first carrier from the flexible cell. The base station may transmit the paging message on the first carrier from the flexible cell to the UE 702. The base station may transmit the paging message on the first carrier from the flexible cell based on the indication. The paging message may be associated with a PDCCH that may schedule a PDSCH. In some aspects, the PDCCH may schedule reception of the PDSCH on a second carrier of the flexible cell. The first carrier and the second carrier of the flexible cell may be non-anchor carriers. In some aspects, the PDCCH may comprise a field that indicates the at least one carrier from the flexible cell to monitor for the PDSCH.

At 712, the UE 702 may monitor the first carrier from the flexible cell for the paging message based on the indication. The paging message may be associated with a PDCCH that schedules a PDSCH. In some aspects, the PDCCH may schedule reception of the PDSCH on a second carrier of the flexible cell. In some aspects, the first carrier and the second carrier of the flexible cell may be non-anchor carriers. In some aspects, the first carrier may be monitored for the PDCCH and the PDCSH if the indication does not indicate the at least one carrier from the flexible cell to monitor for the paging message. In some aspects, a SSB or a SIB1 may be received via the first carrier. In some aspects, the PDCCH may comprise a field that indicates the at least one carrier from the flexible cell to monitor for the PDSCH.

At 714, the UE 702 may communicate with the base station 704. For example, the UE may receive the PDSCH scheduled by the PDCCH. The PDSCH may be received on the first carrier or the second carrier of the flexible cell

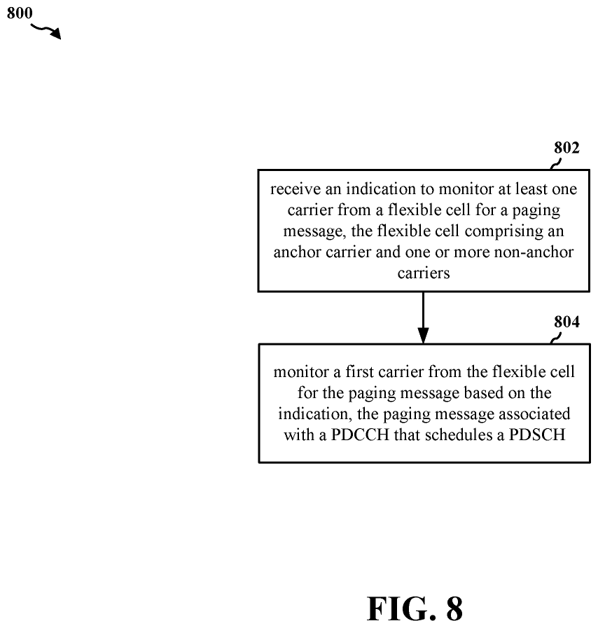

FIG. 8 is a flowchart 800 of a method of wireless communication. The method may be performed by a UE or a component of a UE (e.g., the UE 104; the apparatus 1002; the cellular baseband processor 1004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to monitor one or more carriers of a flexible cell for paging messages.

At 802, the UE may receive an indication to monitor at least one carrier from a flexible cell. For example, 802 may be performed by indication component 1042 of apparatus 1002. The UE may receive the indication to monitor the at least one carrier from a base station. The flexible cell may be associated with the base station. The UE may receive the indication to monitor the at least one carrier from the flexible cell for a paging message. The flexible cell may comprise an anchor carrier and one or more non-anchor carriers. In some aspects, the indication may comprise at least one of a SI, a MIB, a PEI, or a paging TRS availability indication. In some aspects, the indication may schedule the first carrier from the flexible cell for reception of the PDCCH and the PDSCH.

At 804, the UE may monitor a first carrier from the flexible cell for the paging message. For example, 804 may be performed by monitor component 1044 of apparatus 1002. The UE may monitor the first carrier from the flexible cell for the paging message based on the indication. The paging message may be associated with a PDCCH that schedules a PDSCH. In some aspects, the PDCCH may schedule reception of the PDSCH on a second carrier of the flexible cell. In some aspects, the first carrier and the second carrier of the flexible cell may be non-anchor carriers. In some aspects, the first carrier may be monitored for the PDCCH and the PDCSH if the indication does not indicate the at least one carrier from the flexible cell to monitor for the paging message. In some aspects, an SSB or a system information block type 1 (SIB1) may be received via the first carrier. In some aspects, the PDCCH may comprise a field that indicates the at least one carrier from the flexible cell to monitor for the PDSCH.

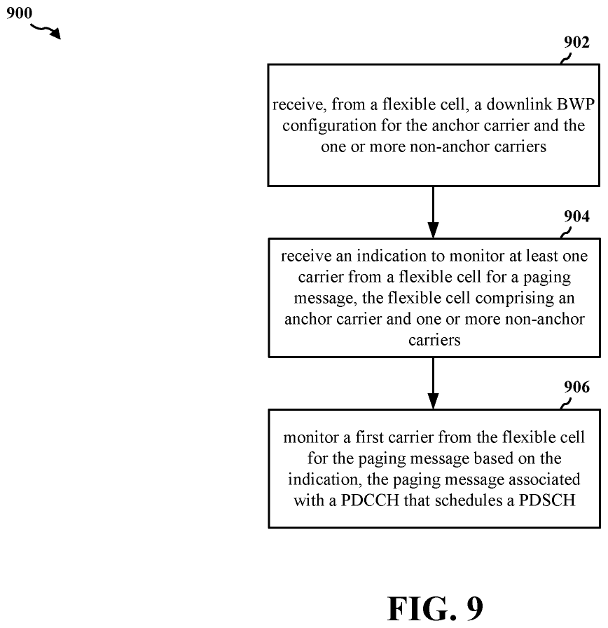

FIG. 9 is a flowchart 900 of a method of wireless communication. The method may be performed by a UE or a component of a UE (e.g., the UE 104; the apparatus 1002; the cellular baseband processor 1004, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to monitor one or more carriers of a flexible cell for paging messages.

At 902, the UE may receive a downlink BWP configuration. For example, 902 may be performed by configuration component 1040 of apparatus 1002. The UE may receive the downlink BWP configuration from the flexible cell. The downlink BWP configuration may be for the anchor carrier and the one or more non-anchor carriers. In some aspects, one or more paging messages may be monitored in the anchor carrier. In some aspects, each carrier of the flexible cell may comprise a respective downlink BWP. Each downlink BWP may be separated by a frequency offset. In some aspects, a unit of the frequency offset may be based on an SCS of the downlink BWP for the anchor carrier. In some aspects, the unit of the frequency offset may be predetermined. In some aspects, the unit of the frequency offset may be based on a SCS of the downlink BWP for the one or more non-anchor carriers.

At 904, the UE may receive an indication to monitor at least one carrier from a flexible cell. For example, 904 may be performed by indication component 1042 of apparatus 1002. The UE may receive the indication to monitor the at least one carrier from a base station. The flexible cell may be associated with the base station. The UE may receive the indication to monitor the at least one carrier from the flexible cell for a paging message. The flexible cell may comprise an anchor carrier and one or more non-anchor carriers. In some aspects, the indication may comprise at least one of an SI, an MIB, a PEI, or a paging TRS availability indication. In some aspects, the indication may schedule the first carrier from the flexible cell for reception of the PDCCH and the PDSCH.

At 906, the UE may monitor a first carrier from the flexible cell for the paging message. For example, 906 may be performed by monitor component 1044 of apparatus 1002. The UE may monitor the first carrier from the flexible cell for the paging message based on the indication. The paging message may be associated with a PDCCH that schedules a PDSCH. In some aspects, the PDCCH may schedule reception of the PDSCH on a second carrier of the flexible cell. In some aspects, the first carrier and the second carrier of the flexible cell may be non-anchor carriers. In some aspects, the first carrier may be monitored for the PDCCH and the PDCSH if the indication does not indicate the at least one carrier from the flexible cell to monitor for the paging message. In some aspects, a SSB or a SIB1 may be received via the first carrier. In some aspects, the PDCCH may comprise a field that indicates the at least one carrier from the flexible cell to monitor for the PDSCH.

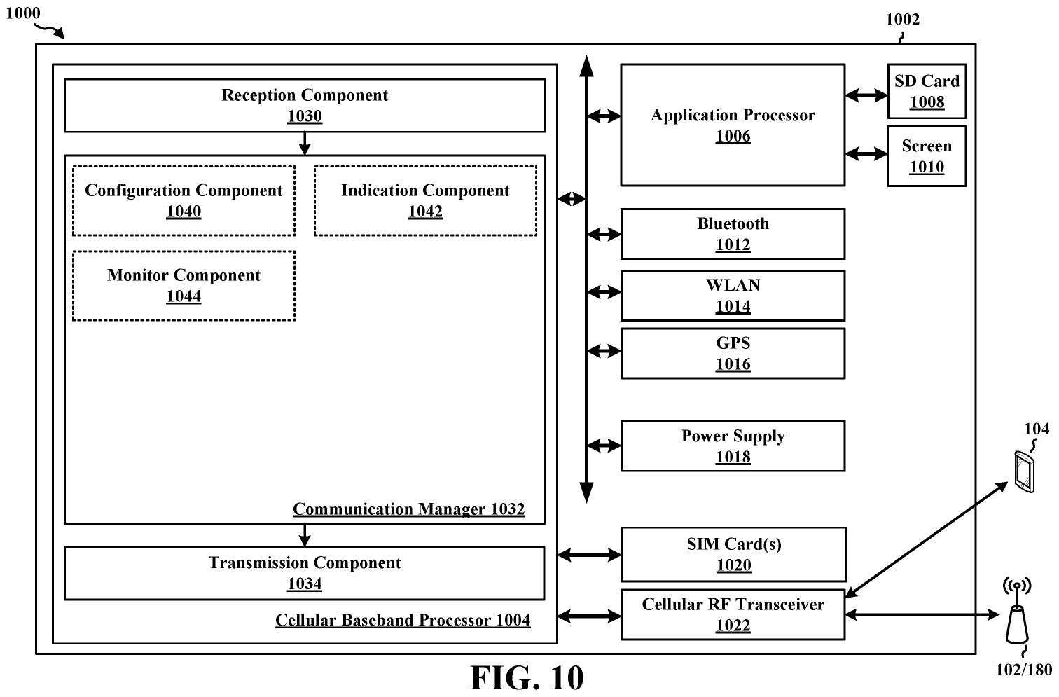

FIG. 10 is a diagram 1000 illustrating an example of a hardware implementation for an apparatus 1002. The apparatus 1002 may be a UE, a component of a UE, or may implement UE functionality. In some aspects, the apparatus 1002 may include a cellular baseband processor 1004 (also referred to as a modem) coupled to a cellular RF transceiver 1022. In some aspects, the apparatus 1002 may further include one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, or a power supply 1018. The cellular baseband processor 1004 communicates through the cellular RF transceiver 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 350 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see 350 of FIG. 3) and include the additional modules of the apparatus 1002.

The communication manager 1032 includes a configuration component 1040 that is configured to receive a downlink BWP configuration, e.g., as described in connection with 902 of FIG. 9. The communication manager 1032 further includes an indication component 1042 that is configured to receive an indication to monitor at least one carrier from a flexible cell, e.g., as described in connection with 802 of FIG. 8 or 904 of FIG. 9. The communication manager 1032 further includes a monitor component 1044 that is configured to monitor a first carrier from the flexible cell for the paging message, e.g., as described in connection with 804 of FIG. 8 or 906 of FIG. 9.

The apparatus may include additional components that perform each of the blocks of the algorithm in the flowcharts of FIGS. 8 and 9. As such, each block in the flowcharts of FIGS. 8 and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1002 may include a variety of components configured for various functions. In one configuration, the apparatus 1002, and in particular the cellular baseband processor 1004, includes means for receiving an indication to monitor at least one carrier from a flexible cell for a paging message. The flexible cell comprising an anchor carrier and one or more non-anchor carriers. The apparatus includes means for monitoring a first carrier from the flexible cell for the paging message based on the indication. The paging message associated with a PDCCH that schedules a PDSCH. The apparatus further includes means for receiving, from the flexible cell, a downlink BWP configuration for the anchor carrier and the one or more non-anchor carriers. The means may be one or more of the components of the apparatus 1002 configured to perform the functions recited by the means. As described supra, the apparatus 1002 may include the TX Processor 368, the RX Processor 356, and the controller/processor 359. As such, in one configuration, the means may be the TX Processor 368, the RX Processor 356, and the controller/processor 359 configured to perform the functions recited by the means.

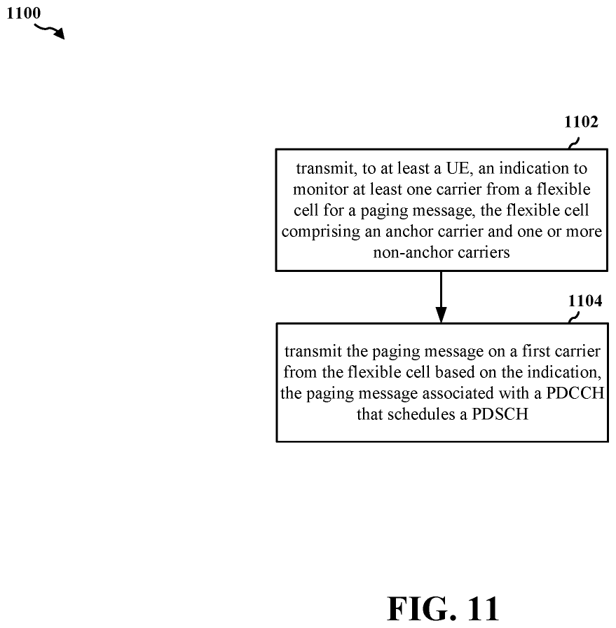

FIG. 11 is a flowchart 1100 of a method of wireless communication. The method may be performed by a base station or a component of a base station (e.g., the base station 102/180; the apparatus 1302; the baseband unit 1304, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to configure a UE to monitor one or more carriers of a flexible cell for paging messages.

At 1102, the base station may transmit an indication to monitor at least one carrier from a flexible cell. For example, 1102 may be performed by indication component 1342 of apparatus 1302. The base station may transmit the indication to monitor the at least one carrier from the flexible cell to a UE. The base station may transmit the indication to monitor the at least one carrier from the flexible cell for a paging message. The base station may comprise the flexible cell. The flexible cell may comprise an anchor carrier and one or more non-anchor carriers. In some aspects, the indication may comprise at least one of a SI, a MIB, a PEI, or a paging TRS availability indication. In some aspects, the indication may schedule the first carrier from the flexible cell for reception of the PDCCH and the PDSCH.

At 1104, the base station may transmit the paging message on a first carrier from the flexible cell. For example, 1104 may be performed by paging component 1344 of apparatus 1302. The base station may transmit the paging message on the first carrier from the flexible cell to the UE. The base station may transmit the paging message on the first carrier from the flexible cell based on the indication. The paging message may be associated with a PDCCH that may schedule a PDSCH. In some aspects, the PDCCH may schedule reception of the PDSCH on a second carrier of the flexible cell. The first carrier and the second carrier of the flexible cell may be non-anchor carriers. In some aspects, the PDCCH may comprise a field that indicates the at least one carrier from the flexible cell to monitor for the PDSCH.

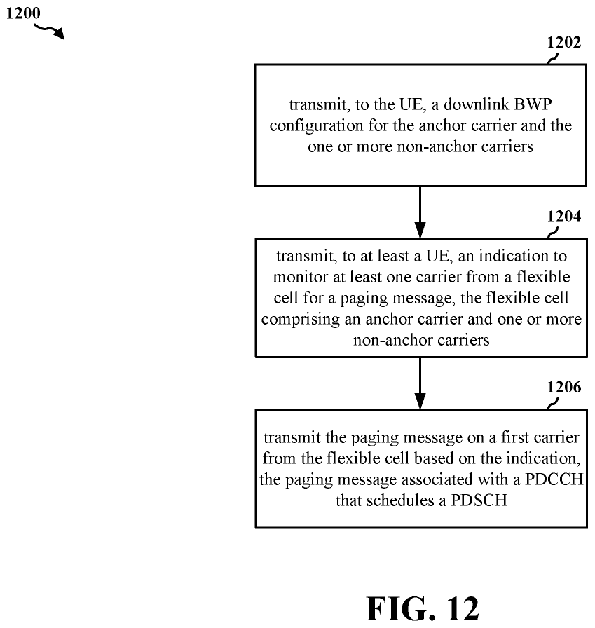

FIG. 12 is a flowchart 1200 of a method of wireless communication. The method may be performed by a base station or a component of a base station (e.g., the base station 102/180; the apparatus 1302; the baseband unit 1304, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to configure a UE to monitor one or more carriers of a flexible cell for paging messages.

At 1202, the base station may transmit a downlink BWP configuration. For example, 1202 may be performed by configuration component 1340 of apparatus 1302. The base station may transmit the downlink BWP configuration to the UE. The downlink BWP configuration may be for the anchor carrier and the one or more non-anchor carriers. In some aspects, each carrier of the flexible cell may comprise a respective downlink BWP. Each downlink BWP may be separated by a frequency offset. In some aspects, a unit of the frequency offset may be based on a SCS of the downlink BWP for the anchor carrier. In some aspects, the unit of the frequency offset may be predetermined. In some aspects, the unit of the frequency offset may be based on a SCS of the downlink BWP for the one or more non-anchor carriers. In some aspects, the paging messages may be transmitted in the anchor carrier.

At 1204, the base station may transmit an indication to monitor at least one carrier from a flexible cell. For example, 1204 may be performed by indication component 1342 of apparatus 1302. The base station may transmit the indication to monitor the at least one carrier from the flexible cell to a UE. The base station may transmit the indication to monitor the at least one carrier from the flexible cell for a paging message. The base station may comprise the flexible cell. The flexible cell may comprise an anchor carrier and one or more non-anchor carriers. In some aspects, the indication may comprise at least one of a SI, a MIB, a PEI, or a paging TRS availability indication. In some aspects, the indication may schedule the first carrier from the flexible cell for reception of the PDCCH and the PDSCH.

At 1206, the base station may transmit the paging message on a first carrier from the flexible cell. For example, 1206 may be performed by paging component 1344 of apparatus 1302. The base station may transmit the paging message on the first carrier from the flexible cell to the UE. The base station may transmit the paging message on the first carrier from the flexible cell based on the indication. The paging message may be associated with a PDCCH that may schedule a PDSCH. In some aspects, the PDCCH may schedule reception of the PDSCH on a second carrier of the flexible cell. The first carrier and the second carrier of the flexible cell may be non-anchor carriers. In some aspects, the PDCCH may comprise a field that indicates the at least one carrier from the flexible cell to monitor for the PDSCH.

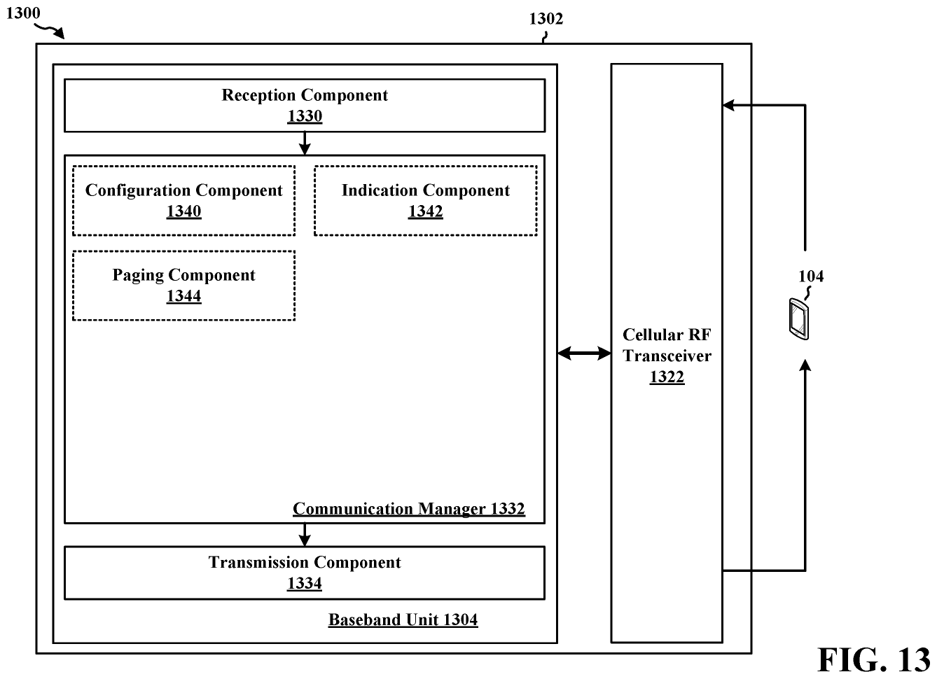

FIG. 13 is a diagram 1300 illustrating an example of a hardware implementation for an apparatus 1302. The apparatus 1302 may be a base station, a component of a base station, or may implement base station functionality. In some aspects, the apparatus 1302 may include a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station 310 and may include the memory 376 and/or at least one of the TX processor 316, the RX processor 370, and the controller/processor 375.

The communication manager 1332 includes a configuration component 1340 that may transmit a downlink BWP configuration, e.g., as described in connection with 1202 of FIG. 12. The communication manager 1332 further includes an indication component 1342 that may transmit an indication to monitor at least one carrier from a flexible cell, e.g., as described in connection with 1102 of FIG. 11 or 1204 of FIG. 12. The communication manager 1332 further includes a paging component 1344 that may transmit the paging message on a first carrier from the flexible cell, e.g., as described in connection with 1104 of FIG. 11 or 1206 of FIG. 12.

The apparatus may include additional components that perform each of the blocks of the algorithm in the flowcharts of FIGS. 11 and 12. As such, each block in the flowcharts of FIGS. 11 and 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the baseband unit 1304, includes means for transmitting, to at least a UE, an indication to monitor at least one carrier from a flexible cell for a paging message. The flexible cell comprising an anchor carrier and one or more non-anchor carriers. The apparatus includes means for transmitting the paging message on a first carrier from the flexible cell based on the indication. The paging message associated with a PDCCH that schedules a PDSCH. The apparatus further includes means for transmitting, to the UE, a downlink BWP configuration for the anchor carrier and the one or more non-anchor carriers. The means may be one or more of the components of the apparatus 1302 configured to perform the functions recited by the means. As described supra, the apparatus 1302 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to receive an indication to monitor at least one carrier from a flexible cell for a paging message, the flexible cell comprising an anchor carrier and one or more non-anchor carriers; and monitor a first carrier from the flexible cell for the paging message based on the indication, the paging message associated with a PDCCH that schedules a PDSCH.

Aspect 2 is the apparatus of aspect 1, further including a transceiver coupled to the at least one processor.

Aspect 3 is the apparatus of any of aspects 1 and 2, further includes that the indication comprises at least one of a SI, a MIB, a PEI, or a paging TRS availability indication.

Aspect 4 is the apparatus of any of aspects 1-3, further includes that the indication schedules the first carrier from the flexible cell for reception of the PDCCH and the PDSCH.

Aspect 5 is the apparatus of any of aspects 1-4, further includes that the PDCCH schedules reception of the PDSCH on a second carrier of the flexible cell.

Aspect 6 is the apparatus of any of aspects 1-5, further includes that the first carrier and the second carrier of the flexible cell are non-anchor carriers.

Aspect 7 is the apparatus of any of aspects 1-6, further includes that the first carrier is monitored for the PDCCH and the PDSCH if the indication does not indicate the at least one carrier from the flexible cell to monitor for the paging message.

Aspect 8 is the apparatus of any of aspects 1-7, further includes that an SSB or a SIB1 is received via the first carrier.

Aspect 9 is the apparatus of any of aspects 1-8, further includes that the PDCCH comprises a field that indicates the at least one carrier from the flexible cell to monitor for the PDSCH.

Aspect 10 is the apparatus of any of aspects 1-9, further includes that the at least one processor is further configured to receive, from the flexible cell, a downlink BWP configuration for the anchor carrier and the one or more non-anchor carriers.

Aspect 11 is the apparatus of any of aspects 1-10, further includes that paging messages are monitored in the anchor carrier.

Aspect 12 is the apparatus of any of aspects 1-11, further includes that each carrier of the flexible cell comprises a respective downlink BWP.

Aspect 13 is the apparatus of any of aspects 1-12, further includes that each downlink BWP is separated by a frequency offset.

Aspect 14 is the apparatus of any of aspects 1-13, further includes that a unit of the frequency offset is based on a SCS of the downlink BWP for the anchor carrier.

Aspect 15 is the apparatus of any of aspects 1-14, further includes that a unit of the frequency offset is predetermined.

Aspect 16 is the apparatus of any of aspects 1-15, further includes that a unit of the frequency offset is based on a SCS of the downlink BWP for the one or more non-anchor carriers.

Aspect 17 is a method of wireless communication for implementing any of aspects 1-16.

Aspect 18 is an apparatus for wireless communication including means for implementing any of aspects 1-16.

Aspect 19 is a computer-readable medium storing computer executable code, where the code when executed by a processor causes the processor to implement any of aspects 1-16.

Aspect 20 is an apparatus for wireless communication at a base station including at least one processor coupled to a memory and configured to transmit, to at least a UE, an indication to monitor at least one carrier from a flexible cell for a paging message, the flexible cell comprising an anchor carrier and one or more non-anchor carriers; and transmit the paging message on a first carrier from the flexible cell based on the indication, the paging message associated with a PDCCH that schedules a PDSCH.

Aspect 21 is the apparatus of aspect 20, further including a transceiver coupled to the at least one processor.

Aspect 22 is the apparatus of any of aspects 20 and 21, further includes that the indication comprises at least one of a SI, a MIB, a PEI, or a paging TRS availability indication.

Aspect 23 is the apparatus of any of aspects 20-22, further includes that the indication schedules the first carrier from the flexible cell for reception of the PDCCH and the PDSCH.

Aspect 24 is the apparatus of any of aspects 20-23, further includes that the PDCCH schedules reception of the PDSCH on a second carrier of the flexible cell.

Aspect 25 is the apparatus of any of aspects 20-24, further includes that the first carrier and the second carrier of the flexible cell are non-anchor carriers.

Aspect 26 is the apparatus of any of aspects 20-25, further includes that the PDCCH comprises a field that indicates the at least one carrier from the flexible cell to monitor for the PDSCH.

Aspect 27 is the apparatus of any of aspects 20-26, further includes that the at least one processor is further configured to transmit, to the UE, a downlink BWP configuration for the anchor carrier and the one or more non-anchor carriers.

Aspect 28 is the apparatus of any of aspects 20-27, further includes that each carrier of the flexible cell comprises a respective downlink BWP.

Aspect 29 is the apparatus of any of aspects 20-28, further includes that each downlink BWP is separated by a frequency offset.

Aspect 30 is the apparatus of any of aspects 20-29, further includes that a unit of the frequency offset is based on a SCS of the downlink BWP for the anchor carrier, is predetermined, or is based on the SCS of the downlink BWP for the one or more non-anchor carriers.

Aspect 31 is the apparatus of any of aspects 20-30, further includes that paging messages are transmitted in the anchor carrier.

Aspect 32 is a method of wireless communication for implementing any of aspects 20-31.

Aspect 33 is an apparatus for wireless communication including means for implementing any of aspects 20-31.

Aspect 34 is a computer-readable medium storing computer executable code, where the code when executed by a processor causes the processor to implement any of aspects 20-31.

What is claimed is:

1. An apparatus for wireless communication at a user equipment (UE), comprising:
a memory; and
at least one processor coupled to the memory and configured to:
receive an indication to monitor at least one carrier from a flexible cell for a paging message, the flexible cell comprising an anchor carrier and one or more non-anchor carriers; and
monitor a first carrier from the flexible cell for the paging message based on the indication, the paging message associated with a physical downlink control channel (PDCCH) that schedules a physical downlink shared channel (PDSCH).

2. The apparatus of claim 1, further comprising a transceiver coupled to the at least one processor.

3. The apparatus of claim 1, wherein the indication comprises at least one of a system information (SI), a master information block (MIB), a paging early indication (PEI), or a paging tracking reference signal (TRS) availability indication.

4. The apparatus of claim 1, wherein the indication schedules the first carrier from the flexible cell for reception of the PDCCH and the PDSCH.

5. The apparatus of claim 1, wherein the PDCCH schedules reception of the PDSCH on a second carrier of the flexible cell.

6. The apparatus of claim 5, wherein the first carrier and the second carrier of the flexible cell are non-anchor carriers.

7. The apparatus of claim 1, wherein the first carrier is monitored for the PDCCH and the PDSCH if the indication does not indicate the at least one carrier from the flexible cell to monitor for the paging message.

8. The apparatus of claim 7, wherein a synchronization signal block (SSB) or a system information block type 1 (SIB1) is received via the first carrier.

9. The apparatus of claim 1, wherein the PDCCH comprises a field that indicates the at least one carrier from the flexible cell to monitor for the PDSCH.

10. The apparatus of claim 1, wherein the at least one processor is further configured to:
receive, from the flexible cell, a downlink bandwidth part (BWP) configuration for the anchor carrier and the one or more non-anchor carriers.

11. The apparatus of claim 10, wherein paging messages are monitored in the anchor carrier.

12. The apparatus of claim 10, wherein each carrier of the flexible cell comprises a respective downlink BWP.

13. The apparatus of claim 12, wherein each downlink BWP is separated by a frequency offset.

14. The apparatus of claim 13, wherein a unit of the frequency offset is based on a subcarrier spacing (SCS) of the downlink BWP for the anchor carrier.

15. The apparatus of claim 13, wherein a unit of the frequency offset is predetermined.

16. The apparatus of claim 13, wherein a unit of the frequency offset is based on a subcarrier spacing (SCS) of the downlink BWP for the one or more non-anchor carriers.

17. A method of wireless communication at a user equipment (UE), comprising:
receiving an indication to monitor at least one carrier from a flexible cell for a paging message, the flexible cell comprising an anchor carrier and one or more non-anchor carriers; and
monitoring a first carrier from the flexible cell for the paging message based on the indication, the paging message associated with a physical downlink control channel (PDCCH) that schedules a physical downlink shared channel (PDSCH).

18. An apparatus for wireless communication at a base station, comprising:
a memory; and
at least one processor coupled to the memory and configured to:
transmit, to at least a user equipment (UE), an indication to monitor at least one carrier from a flexible cell for a paging message, the flexible cell comprising an anchor carrier and one or more non-anchor carriers; and
transmit the paging message on a first carrier from the flexible cell based on the indication, the paging message associated with a physical downlink control channel (PDCCH) that schedules a physical downlink shared channel (PDSCH).

19. The apparatus of claim 18, further comprising a transceiver coupled to the at least one processor.

20. The apparatus of claim 18, wherein the indication comprises at least one of a system information (SI), a master information block (MIB), a paging early indication (PEI), or a paging tracking reference signal (TRS) availability indication.

21. The apparatus of claim 18, wherein the indication schedules the first carrier from the flexible cell for reception of the PDCCH and the PDSCH.

22. The apparatus of claim 18, wherein the PDCCH schedules reception of the PDSCH on a second carrier of the flexible cell.

23. The apparatus of claim 22, wherein the first carrier and the second carrier of the flexible cell are non-anchor carriers.

24. The apparatus of claim 18, wherein the PDCCH comprises a field that indicates the at least one carrier from the flexible cell to monitor for the PDSCH.

25. The apparatus of claim 18, wherein the at least one processor is further configured to:
transmit, to the UE, a downlink bandwidth part (BWP) configuration for the anchor carrier and the one or more non-anchor carriers.

26. The apparatus of claim 25, wherein each carrier of the flexible cell comprises a respective downlink BWP.

27. The apparatus of claim 26, wherein each downlink BWP is separated by a frequency offset.

28. The apparatus of claim 27, wherein a unit of the frequency offset is based on a subcarrier spacing (SCS) of the downlink BWP for the anchor carrier, is predetermined, or is based on the SCS of the downlink BWP for the one or more non-anchor carriers.

29. The apparatus of claim 25, wherein paging messages are transmitted in the anchor carrier.

30. A method of wireless communication at a base station, comprising:
transmitting, to at least a user equipment (UE), an indication to monitor at least one carrier from a flexible cell for a paging message, the flexible cell comprising an anchor carrier and one or more non-anchor carriers; and
transmitting the paging message on a first carrier from the flexible cell based on the indication, the paging message associated with a physical downlink control channel (PDCCH) that schedules a physical downlink shared channel (PDSCH).
